(19) United States
(12) Patent Application Publication
(10) Pub. No.: US 2007/0092604 A1
(43) Pub. Date: Apr. 26, 2007

(54) Enzymatic Treatment Process for Cereal Grains

(75) Inventor: Jeffrey P. Robert, Williamsburg, VA (US)

Correspondence Address: JOY L BRYANT, P.C., P O BOX 620, LIGHTFOOT, VA, 23090-0620, US

(73) Assignee: DELTA-T CORPORATION, Williamsburg, VA (US)

(21) Appl. No.: 11/552,010

(22) Filed: Oct. 23, 2006

Related U.S. Application Data
(60) Provisional application No. 60/729,588, filed on Oct. 24, 2005.

(51) Int. Cl. A23L 1/10

(52) U.S. Cl. 426/28

(57) ABSTRACT

An enzymatic treatment process for cereal grains is presented. A cereal grain having at least one layer surrounding an endosperm core is provided. The cereal grain is exposed to a mixture comprising water and at least one enzyme. The exposure time is sufficient to allow the mixture to penetrate through at least one layer of the cereal grain wherein at least one layer is broken down from the endosperm core without requiring mechanical destruction of the cereal grain.

### CROSS-REFERENCE TO RELATED APPLICATIONS

This application claims the benefit of U.S. Provisional Patent Application Ser. No. 60/729,588, entitled, “Cereal Grain Separation Process,” filed Oct. 24, 2005, which is hereby incorporated by reference in its entirety.

### FIELD OF THE INVENTION

The present invention relates to cereal grain separation processes. In particular, it relates to an enzymatic treatment process for cereal grains that is employed before any mechanical separation process occurs.

### BACKGROUND OF THE INVENTION

In general, a cereal grain 10 has an outer layer 20, a single celled aleurone layer 30, and a starchy endosperm core 40 (see FIG. 1). Many industrial processes require the separation of these layers in order to obtain various finished products such as animal feed, starches, and oils. In processing cereal grains, typically either a wet milling process, a dry milling process, or a combination process is employed to separate the grain. Regardless of whether the process is a wet or dry milling process, the grain is subjected to a tempering step in order to soften and expand the grain layers, making them more pliable and weakening the bond between the wetted outer layer, such as a germ layer or the bran/fiber layer, and the endosperm. This allows the outer layer to easily be removed from the endosperm. The tempering step typically involves soaking or steeping the grain in a grain to water ratio of approximately 1:1.5 and 1:2 for a certain amount of time. Once the grain has been tempered, the softened grain is ruptured by some mechanical means, where the outer layer is physically separated from the endosperm layer. This process is expensive and not very energy efficient because it requires quantities of water, which result in waste water that must be treated and strict control of holding times. If the grain is held too long, the inter-cellular bonds break down and damage the endosperm layer.

Various processes have been proposed to recover the different grain layers. Johnston et al. in U.S. Pat. No. 6,899,910 disclose a dry grind process where corn kernels are soaked in water, ground into a slurry, and incubated with at least one enzyme (amylase, protease or cell wall degrading) to increase the specific gravity of the slurry so the corn germ and the corn coarse fiber floats to the top of the slurry. The corn germ and corn coarse fiber are then recovered. Optionally, ethanol is produced from the slurry once it no longer contains the corn germ and the corn coarse fiber.

In U.S. Pat. No. 6,566,125 to Johnston et al., a method is disclosed for obtaining starch from maize. The method involves hydrating the corn kernel in water for 1-6 hours so that the germ is completely hydrated and becomes pliable enough that it does not break when the corn is coarsely ground; coarsely grinding the corn to produce a slurry; and treating the coarsely ground corn slurry with exogenous or endogenous enzyme (e.g., protease) for 0.5-6 hours. After enzyme treatment, the corn is milled using the normal corn wet-milling methods.

An object of the present invention is to provide an enzymatic treatment process for cereal grains that involves an initial step of exposing the cereal grain to a mixture comprising water and at least one enzyme prior to a tempering step or any mechanical destruction of the cereal grain in a cereal grain milling process.

### SUMMARY OF THE INVENTION

By the present invention, an enzymatic treatment process for cereal grains is presented. The process involves providing cereal grain having at least one layer surrounding an endosperm core. A mixture comprising water and at least one enzyme is provided and the cereal grain is exposed to the mixture. The length of the exposure time is sufficient to allow the mixture to penetrate through at least one layer of the cereal grain. At least one layer of the cereal grain surrounding the endosperm core is broken down from the endosperm core without requiring tempering or mechanical destruction of the grain. After the enzymatic treatment process, the grain is then subjected to a mechanical reduction process or a tempering process. By exposing the cereal grain to the enzyme mixture, the tempering time is significantly reduced.

Additional objects and advantages of the invention will be set forth in part in the description which follows, and in part, will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principals thereof, and in which:

FIG. 1 is a sectional view of the general structure of a cereal grain.

FIG. 2 is a flow chart showing the process of the present invention where a mechanical reduction step is incorporated into the process.

### DETAILED DESCRIPTION OF THE PREFERRED EMBODIMENTS

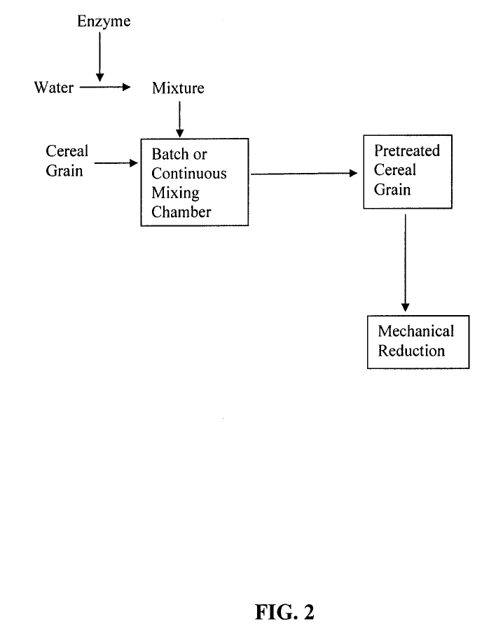

The process of the present invention has a key distinction from other cereal grain processes. The process of the present invention is directed toward a pre-treatment step for the cereal grain that occurs before the cereal grain undergoes any tempering or other milling process. The advantage to the pre-treatment step is that it enables break down of the layers of the grain without mechanically destroying the grain. Hence, the process improves the separation of the grain's components, thus reducing tempering and milling times. FIG. 2 is a flow chart depicting the process of the present invention. The figure shows the addition of an enzyme/water mixture to cereal grain through a batch or continuous mixing chamber. In a preferred embodiment, the pre-treated cereal grain is mechanically reduced.

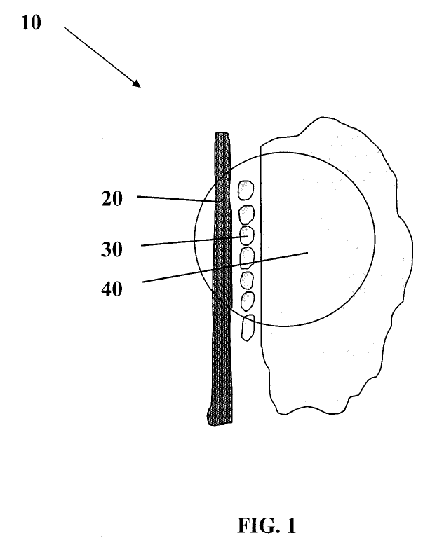

The process begins by providing whole cereal grain. By the word “whole” it is meant that the cereal grain is used as is, without any changes to the physical or chemical characteristics of the cereal grain. Any cereal grain known to one of ordinary skill in the art is suitable for use in the present invention, provided that such grain is a starch-bearing grain and not a grain such as soy or kidney bean. The general structure of the cereal grain of the present invention is shown in FIG. 1. A typical cereal grain 10 has, at a minimum, an outer bran/fiber layer 20, a single celled aleurone layer 30, and a starchy endosperm core 40. Examples of such grains include but are not limited to: corn, wheat, sorghum, barley, rice, oats, rye, millet, and triticale. Preferably, the cereal grain is either corn, wheat, barley, or rye. Most preferably, the cereal grain is wheat.

A mixture comprising water and at least one enzyme is prepared (water/enzyme mixture). Preferably, the mixture is added in an amount ranging from about 0.5% by weight of grain up to about 200% by weight of grain. More preferably, the mixture is added in an amount ranging from about 0.5% by weight of grain up to about 10% by weight of grain. The enzyme concentration within the mixture with respect to the cereal grain is added at an amount ranging from about 0.01 kg enzyme per metric ton of cereal grain to about 10 kg enzyme per metric ton of cereal grain. Preferably, the enzyme concentration ranges from about 0.10 kg enzyme per metric ton of cereal grain to 1.00 kg per metric ton of cereal grain. The enzyme concentration is calculated based on the amount of cereal grain to be treated. At a minimum, the mixture must contain water and at least one enzyme. Blends of enzymes are incorporated to enhance the break down of the various layers of the cereal grain. Alternatively, other additives and preservatives are incorporated to enhance shelf-life and provide other necessary characteristics to the mixture. Suitable enzymes for the present invention include those that are capable of breaking down cell walls (preferably the aleurone layer) and proteins, such as cellulase, beta glucanase, and protease enzymes. Such enzymes are commercially available from Novozymes and are known as: NOVOZYM 50003 and NOVOZYM 50024. Conversely, enzymes such as amylase or glucanase are not desirable or useful in the present invention as these enzymes fail to break down the layers surrounding the endosperm. The enzymes are employed in the present invention in order to accelerate softening of the grain and encourage separation of the layers surrounding the endosperm, not to change the specific gravity of a slurry as described in the prior art. More specifically, it is an object of the present invention to use the mixture to soften or break down at least one layer, such as the bran/fiber layer and, more preferably, the aleurone layer of the grain without penetrating or saturating the endosperm and germ portions of the cereal grain.

The softening or break down effect is achieved by exposing the cereal grain to the water/enzyme mixture for a time sufficient to allow penetration of the mixture through at least one layer of the cereal grain such as the bran/fiber layer and, more preferably, the aleurone layer up to the endosperm. Any method of exposure is suitable for the present invention including but not limited to misting, spraying, and soaking. Preferably, the mixture is sprayed on the cereal grain. This is achieved by placing the cereal grain in a batch or continuous mixing chamber and spraying the cereal grain with the water/enzyme mixture. The object is not to permit total saturation of the cereal grain with the mixture. Rather, it is desirable to allow water to wick into the cereal grain to soften or break down the aleurone/endosperm interface boundary and allow for easy removal of the outer layer of the grain prior to tempering.

As a further step to the process, the cereal grain is mechanically reduced after exposure to the water/enzyme mixture but prior to a tempering step (see FIG. 2). Mechanical reduction may take place using any method known to one of ordinary skill in the art. In particular, the cereal grain is reduced by abrasion or by milling. This step enables quick and easy removal of the outer layer of the cereal grain prior to tempering. Once the outer layer has been removed, the cereal grain is subjected to a tempering process to further separate the grain into various components necessary for processing into oil, human foodstuffs, animal feed, and ethanol.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

What is claimed is:

1. An enzymatic treatment process for cereal grains, the process comprising the steps of:
a) providing a cereal grain having at least one layer surrounding an endosperm core;
b) providing a mixture comprising water and at least one enzyme; and
c) exposing the cereal grain to the mixture for a time sufficient to allow the mixture to penetrate through at least one layer of the cereal grain wherein at least one layer is broken down from the endosperm core without requiring mechanical destruction of the cereal grain.

2. An enzymatic treatment process for cereal grains according to claim 1, wherein the cereal grain is a starch bearing cereal grain selected from the group consisting of: corn, wheat, sorghum, barley, rice, oats, rye, millet, and triticale.

3. An enzymatic treatment process for cereal grains according to claim 2, wherein the cereal grain is wheat.

4. An enzymatic treatment process for cereal grains according to claim 2, wherein the cereal grain is corn.

5. An enzymatic treatment process for cereal grains according to claim 2, wherein the cereal grain is barley.

6. An enzymatic treatment process for cereal grains according to claim 2, wherein the cereal grain is rye.

7. An enzymatic treatment process for cereal grains according to claim 1, wherein the mixture comprising water and at least one enzyme is provided at an amount ranging from about 0.5% by weight of cereal grain up to about 200% by weight of cereal grain.

8. An enzymatic treatment process for cereal grains according to claim 7, wherein the mixture comprising water and at least one enzyme is provided at an amount ranging from about 0.5% by weight of cereal grain up to about 10% by weight of cereal grain.

9. An enzymatic treatment process for cereal grains according to claim 1, wherein at least one enzyme is selected from the group consisting of: cellulase; beta-glucanase; and protease.

10. An enzymatic treatment process for cereal grains according to claim 1, wherein the enzyme concentration within the mixture with respect to the cereal grain is added at an amount ranging from about 0.01 kg enzyme per metric ton of cereal grain to about 10 kg enzyme per metric ton of cereal grain.

11. An enzymatic treatment process for cereal grains according to claim 10, wherein the enzyme concentration ranges from about 0.10 kg enzyme per metric ton of cereal grain to 1.00 kg per metric ton of cereal grain.

12. An enzymatic treatment process for cereal grains according to claim 1, wherein the cereal grain is exposed to the mixture by misting the cereal grain with the mixture.

13. An enzymatic treatment process for cereal grains according to claim 1, wherein the cereal grain is exposed to the mixture by spraying the cereal grain with the mixture.

14. An enzymatic treatment process for cereal grains according to claim 1, wherein the cereal grain is exposed to the mixture by introducing the cereal grain into a soaking vat containing the mixture.

15. An enzymatic treatment process for cereal grains according to claim 1, further comprising the step of mechanically reducing the cereal grain after exposing the cereal grain to the mixture and removing at least one layer from the cereal grain.

16. An enzymatic treatment process for cereal grains according to claim 15, wherein the cereal grain is mechanically reduced by abrasion.

17. An enzymatic treatment process for cereal grains according to claim 15, wherein the cereal grain is mechanically reduced by milling.

18. An enzymatic treatment process for cereal grains, the process comprising the steps of:
a) providing a starch bearing cereal grain having an aleurone layer surrounding an endosperm core;
b) providing a mixture comprising water and a cellulase enzyme; and
c) spraying the starch bearing cereal grain with the mixture, wherein the mixture penetrates into the aleurone layer breaking down the aleurone layer from the endosperm core without requiring mechanical destruction of the cereal grain.

19. An enzymatic treatment process for cereal grains according to claim 18, wherein the starch bearing cereal grain is wheat.
